(19) United States
(12) Patent Application Publication
(10) Pub. No.: US 2025/0106601 A1
(43) Pub. Date: Mar. 27, 2025

(54) PROCESSING PIPELINE FOR DETERMINATION OF CALL OUTCOME USING SIP MESSAGE

(71) Applicant: FIRST ORION CORP., North Little Rock, AR (US)

(72) Inventors: Perry Lee Claunch, Conway, AR (US); Aaron Christopher Jacobi, Little Rock, AR (US)

(21) Appl. No.: 18/900,483

(22) Filed: Sep. 27, 2024

Related U.S. Application Data
(60) Provisional application No. 63/540,903, filed on Sep. 27, 2023.

(51) Int. Cl. H04W 4/16; H04L 65/1096; H04L 65/1104

(52) U.S. Cl. CPC H04W 4/16; H04L 65/1096; H04L 65/1104

(57) ABSTRACT

An example operation may include one or more of receiving at least one session initiation protocol (SIP) message from a communication session between a sending device and a receiving device, parsing content within the at least one SIP message to identify values within predetermined fields of the at least one SIP message, identifying an outcome of a call event from the communication based on the identified values from the at least one SIP message, and labelling the at least one SIP message with the identified outcome and transferring the labeled at least one SIP message to a downstream system.

### BACKGROUND

A call disposition is the classification of an outcome of a call, providing a brief summary of the interaction. Examples of call dispositions including the call went to voicemail, the call was answered by a human, the call was forwarded to another device, and the like. The classification of calls aids organizations in managing call and analyzing customer interactions, helping improve service strategies and business operations. Determining a call disposition is highly reliant on messaging standards used by a particular carrier. When a system interacts with different carriers, it can be difficult to identify call dispositions because each carrier may have their own messaging standards making it difficult to design a single model for identifying call dispositions.

### SUMMARY

One example embodiment provides an apparatus that includes a memory coupled to a processor, wherein the processor may one or more of receive at least one session initiation protocol (SIP) message from a communication session between a sending device and a receiving device, parse content within the at least one SIP message to identify values within predetermined fields of the at least one SIP message, identify an outcome of a call event from the communication based on the identified values from the at least one SIP message, and label the at least one SIP message with the identified outcome and transfer the labeled at least one SIP message to a downstream system.

Another example embodiment provides a method that includes one or more of receiving at least one session initiation protocol (SIP) message from a communication session between a sending device and a receiving device, parsing content within the at least one SIP message to identify values within predetermined fields of the at least one SIP message, identifying an outcome of a call event from the communication based on the identified values from the at least one SIP message, and labelling the at least one SIP message with the identified outcome and transferring the labeled at least one SIP message to a downstream system.

A further example embodiment provides a computer readable storage medium comprising instructions, that when read by a processor, cause the processor to perform one or more of receiving at least one session initiation protocol (SIP) message from a communication session between a sending device and a receiving device, parsing content within the at least one SIP message to identify values within predetermined fields of the at least one SIP message, identifying an outcome of a call event from the communication based on the identified values from the at least one SIP message, and labelling the at least one SIP message with the identified outcome and transferring the labeled at least one SIP message to a downstream system.

### BRIEF DESCRIPTION OF DRAWINGS

FIG. 1A is a diagram illustrating a processing pipeline for determining a call disposition according to examples and features of the instant solution.

FIG. 1B is a diagram illustrating a classification system for determining a call disposition according to examples and features of the instant solution.

FIG. 2 is a diagram illustrating an example of a SIP message according to examples and features of the instant solution.

FIG. 3A is a diagram illustrating a classification engine identifying a call disposition and labelling a SIP message with the call disposition according to examples and features of the instant solution.

FIG. 3B is a diagram illustrating an example of classification rules that are utilized by the classification engine according to examples and features of the instant solution.

FIG. 4A is a diagram illustrating a method of determining an outcome of a call according to examples and features of the instant solution.

FIG. 4B is a diagram illustrating an additional method of determining an outcome of a call according to examples and features of the instant solution.

FIG. 5 is a system diagram illustrating a computing environment according to the instant solution's example features, structures, or characteristics.

### DETAILED DESCRIPTION

The example embodiments are directed to a unified framework that can be used to enhance the reliability of artificial intelligence (AI) or machine learning (ML) operational pipelines through various validations. The framework may include a toolkit (e.g., a software library, etc.) which includes functions for validating input data against historical data, validating a tokenizer, validating embedded data, validating output data, and the like. In some embodiments, the toolkit may be a PYTHON® library, however, embodiments are not limited thereto.

The example embodiments are directed to a system that can identify a call disposition (outcome of a call) based on attribute values stored within at least one session initial protocol (SIP) message that is transmitted from a sending system to a receiving system. The system can generate a mirrored call path from the call that is transmitted from the sending system to the receiving system so as not to disturb the call in progress. However, the mirrored call path enables the system to analyze the SIP message(s) at the same time (simultaneously) as the call is being performed. The system can determine which call outcome applies, label the call data, such as the SIP message(s) with the determined call outcome, and use the labeled call data to further generate analytics, reports, and the like, for the carrier, the system, the sending system, the receiving system, or the like.

The system may include a software application running on a server or other host platform which applies a proprietary classification model to a set of pre-processed SIP messages with the task of attributing the correct disposition to a specific call event. For these purposes, disposition refers to the result of a phone call, for example, if the call was answered by a human versus answered by a voicemail system, and the like. This system can analyze millions of phone calls daily accounting for hundreds of millions of SIP messages every day. With this data, system is able to provide proprietary analytics and reporting solutions for customers (such as carriers) within the communication ecosystem. This data provides critical performance measures to the enterprise for better understanding of how the system enhances their operations.

In the example embodiments, a call disposition is the term used describe the outcome of a call and answers the question of “what happened to the call?” The disposition essentially captures the dispositions available as results from the classification model. Examples of call dispositions include, but are not limited to, unscored, cancelled, failed, answered, callee declined, unanswered, missing data, rings to voicemail, callee turned phone off, straight to voicemail, forwarded to voicemail, caller hangs up before connected, line busy, callee forwards to another device, and the like.

To attribute the proper disposition, the model uses standard knowledge of SIP standard for various message types used to set up call sessions between two parties. The analysis of SIP data proves challenging as it is possible for SIP standards to be executed in a variety of methods and we are at the mercy of originating and terminating carriers who determine how they want to implement these standards. We also find challenges in that our integration point at the SBC mirrored traffic proves to not be 100% reliable so we must make learned decisions using imperfect data.

In the example embodiments, a call may be executed by SIP messages that flow from a sending system to a receiving system. The call data (SIP messages) may flow through various servers and systems in the carrier network and in the host network of the example embodiments. In some embodiments, session border controllers (SBCs) are mirrored, both before and after, by level 2 traffic mirrors, for example, at a ratio of 4:1. The mirrored data is sent to an aggregator. At the present time, an aggregator may sift through the mirrored call data and match the data to a phone number that has been uploaded. The aggregator may feed the matched call data to an accumulator. The host system described herein may capture the mirrored data along the data flow, for example, after the call data passes through the accumulator.

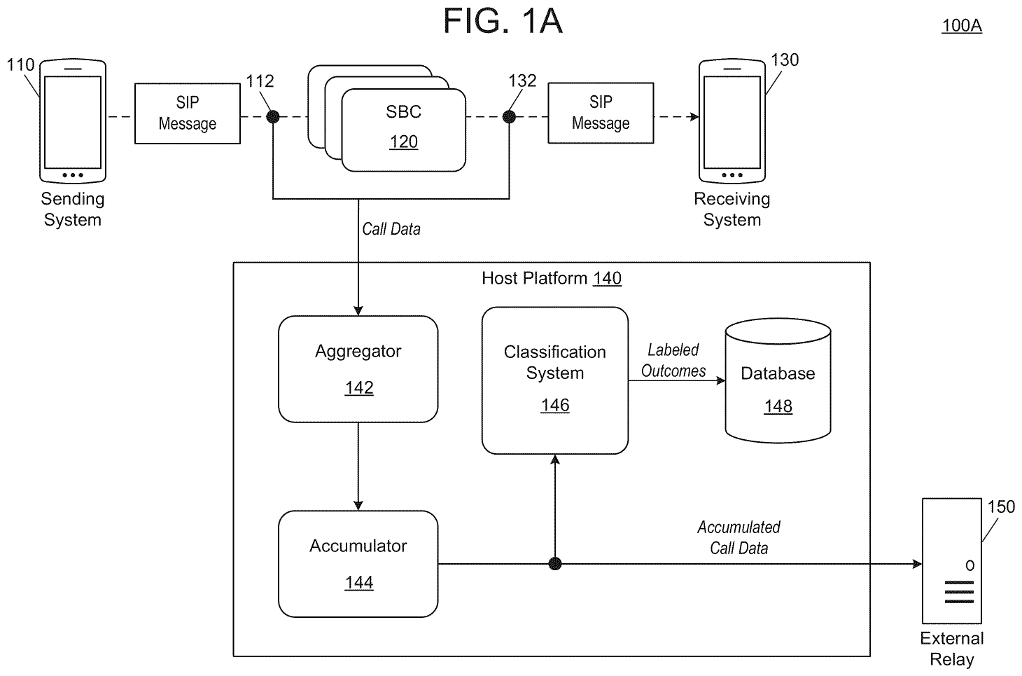

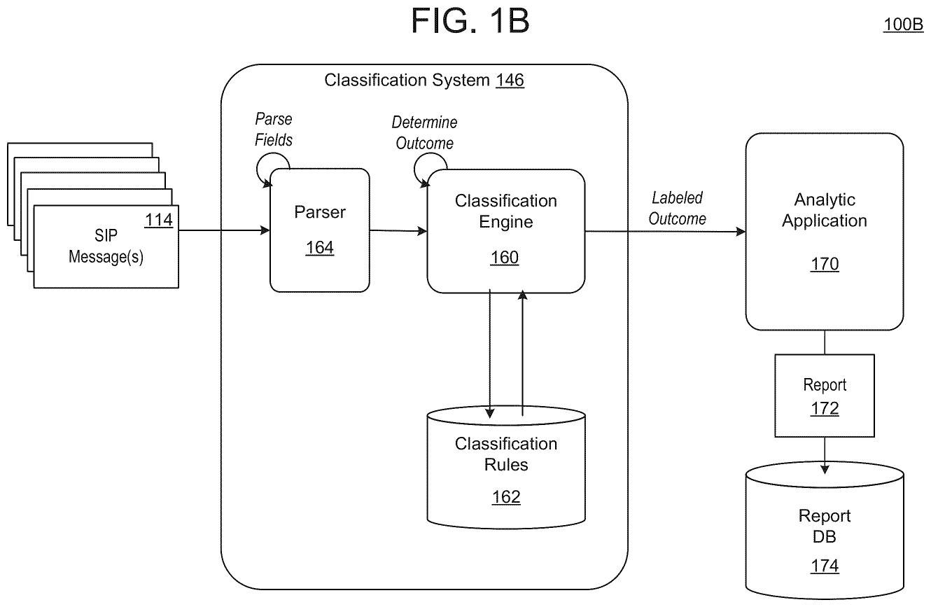

FIG. 1A illustrates a computing environment 100A for determining a call disposition according to examples and features of the instant solution. Referring to FIG. 1A, the computing environment 100A includes a host platform 140 that hosts a processing pipeline for determining a disposition of a call between a sending device 110 and a receiving device 130. The pipeline may include an aggregator 142, an accumulator 144, a classification system 146, and a database 148. In this example, the host platform 140 may include server located on a telephone network, such as an internet protocol (IP) telephone network, Voice over Internet Protocol (VoIP) network, or the like for conducting a telephone call between the sending device 110 and the receiving device 130. The sending device 110 and the receiving device 130 may be IP-phone enabled devices such as IP phones, web phones, mobile phones, or the like.

According to various embodiments, one or more session border controls (SBCs) 120 may be deployed within a telephone network, such as a VoIP network, and may exert control over the signaling and also the media streams involved in setting up, conducting, and terminating telephone calls or other interactive media communications on the VoIP network. At least one SBC 120 may be inserted into the signaling path between the sending device 110 and the receiving device 130. Here, SBCs 120 are capable of receiving session initiation protocol (SIP) messages generated by the sending device 110 and routing it to the receiving device 130, and vice versa. The SBCs 120 can be used to receive SIP messages generated by the sending device 110 and route the SIP messages to the receiving device 130 through the VoIP network.

The host platform described herein may include layer 2 (L2) traffic mirrors 112 and 132 which receive SIP messages 114 from the sending device 110 and/or the receiving device 130 and route the SIP messages to the host platform 140. In this example, the L2 traffic mirrors copy network traffic (e.g., SIP messages 114, etc.) from a layer 2 interface or sub-interface and send the network traffic to the to the aggregator 142. Call data is directed from the layer 2 traffic mirrors, both before and after multiple SBCs, to the aggregator where the data is matched against known phone numbers. Any SIP messages 114 that contain a matched number are sent from the aggregator 142 to the accumulator 144 which may collect data from multiple aggregators 142 (not just a single aggregator). The accumulator 144 may merge the matched messages and sends them to the external relay 150. In addition, the matched messages are also provided to a classification system 146 according to example embodiments.

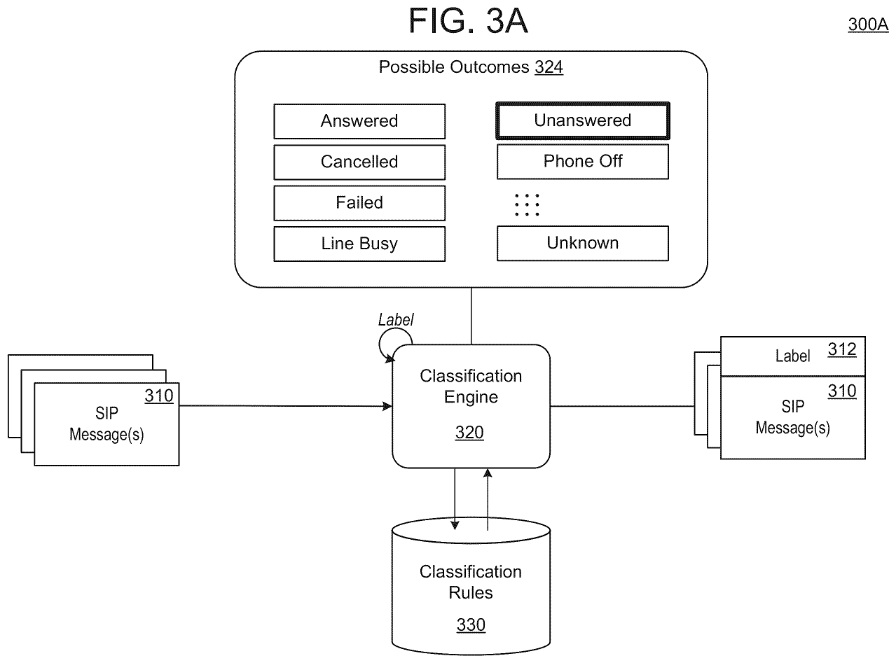

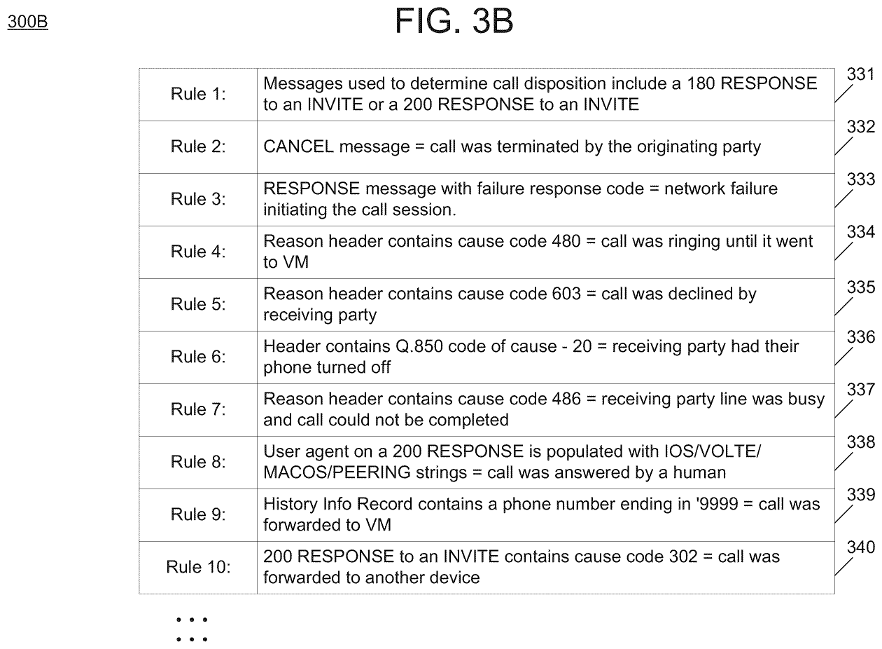

The classification system 146 may determine a disposition of the call associated with the SIP messages 114 between the sending device 110 and the receiving device 130. The call outcome, for example, answered, unanswered and went to voicemail, busy, etc. may be identified by the classification system 146 using classification rules that can be used to analyze SIP message data and determine call outcomes based on values stored within parts of the SIP message 114. For example, cause codes within a header of a SIP message 114 may be used to determine the call outcome. As another example, a combination of attributes, for example, a type of SIP request (e.g., INVITE, ACK, etc.) a type of SIP response (e.g., 180, 200, 400, etc.), codes within a header, codes within a body, and the like. FIG. 3B provides an example of some of the rules that may be used by the classification system 146 to determine a call disposition.

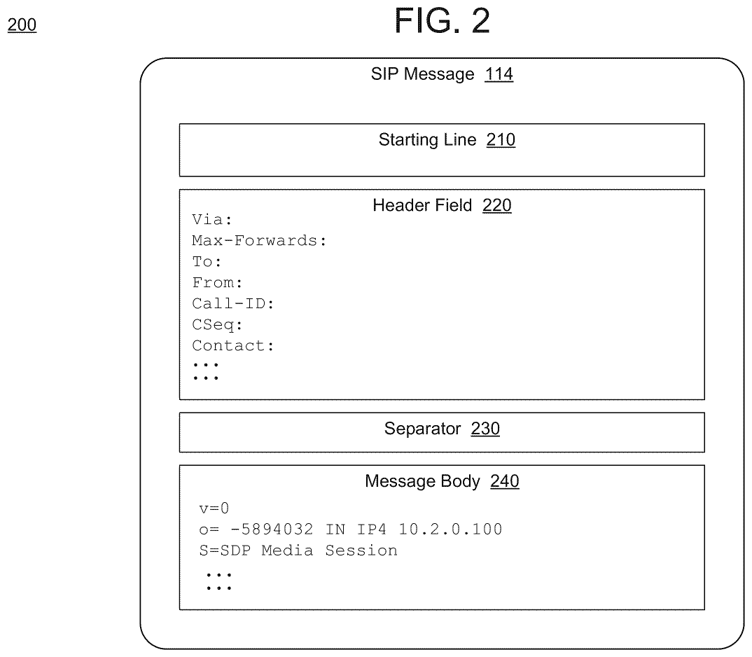

FIG. 1B is a diagram illustrating a view 100B of a classification system 146 for determining a call disposition according to examples and features of the instant solution, and FIG. 2 is a diagram illustrating a view 200 of an example of a SIP message 114 according to examples and features of the instant solution. Referring to FIG. 1B, the classification system 146 includes a classification engine 160 which is capable of reading and interpreting coded rules that are stored within a rules database 162. Furthermore, the classification system 146 includes a parser 164 that can parse SIP messages 114 and identify data values stored therein.

According to various embodiments, the rules may be stored in a machine-readable format within the rules database 162 and may be read by a script, process, etc. executed by the classification engine 160. The classification engine 160 may also contain logic installed therein which can read the rules in machine-readable form and compare the rules to content (values) within fields of the SIP message 114 to identify a call outcome of a call between the sending device 110 and the receiving device 130.

The SIP messages 114 associated with the call may be labeled with a call outcome of the call and passed downstream to at least one of a data store, processing node, software application, etc. In the example of FIG. 1B, the labeled SIP messages can be transferred to an analytic application 170 that can generate metrics that are useful for a carrier based on many labeled SIP messages that are captured, aggregated, and labeled by the classification system 146 of the host platform 140. Furthermore, the analytic application 170 may generate a report 172 (e.g., a digital document, web page, XML document, etc.) which includes the results of the analytics including charts, graphs, metrics, numbers, message data, and the like. The report 172 may be stored within a report database 174 and accessed by other network-connected devices.

Referring now to FIG. 2, the SIP message 114 includes a starting line 210 that identifies a type of SIP request (request URI), a method, and a SIP version, which are included in the SIP message 114, a message header 220, a separator 230 (e.g., a blank line, etc.), and a message body 240. The message header 220 may identify an originator device of the request (sending device 110, a recipient device of the request (receiving device 130), routing data from the sending device to the recipient device for subsequent requests, a sequence number, a call identifier, a trace of the route, and the like. The message body 240 may contain the data being transmitted from the sending device 110 to the receiving device 130 such as dialogue, media, connection information, and the like.

The fields within the SIP message 114 that may be parsed and used for call disposition determination include time such as a timestamp the message is retrieved, an originating phone number, an anonymized version of the receiving phone number, a call ID, a C Seq, a C Seq Method, a Session ID, a response code, a reason, a source IP, a destination IP, a user agent, a history info, and a diversion.

Here, the originating number is the originating phone number for the call flow, the hashed number is an anonymized version of the recipient number, the Call ID is a SIP header field marking the unique identifier for the call event, the C Seq is a SIP header field with an incremental marking assisting with sequence of events, the C Seq Method is a SIP header field populated on SIP Responses and exhibits which message the response is associated with, the session ID is a SIP header field that additionally identifies unique call sessions, the response code is a SIP header field populated on SIP Responses and identifies the type of response similar to HTTP response codes, the reason is a SIP header field that contains more descriptive elements around reasoning behind certain events that may occur in the call flow, the Source IP is the address of the sending party of the SIP message, the Destination IP is the address of the receiving party of the SIP message, the user agent is SIP header field identifying the system device that generated the message, the history info is a SIP header field that contains descriptive information on history of the call flow and certain events that may have transpired, and the diversion is a SIP Header field that contains history elements tracking the network elements that have handled the SIP message.

FIG. 3A illustrates a process 300A of a classification engine 320 identifying a call disposition from f SIP messages 310 and labelling the SIP message 310 with the call disposition according to examples and features of the instant solution. For example, the classification engine 320 may correspond to the classification engine 160 shown in the example of FIG. 1B. In this example, the classification engine 320 may include a plurality of possible outcomes 324 to choose from. Here, the classification engine 320 may receive the SIP messages 310, parse the SIP messages 310 to identify values within predetermined fields of the SIP messages 310, and compare the values to rules stored within classification rules 330 that are stored in a database.

Here, the classification engine 320 identifies the outcome (call disposition) of a call between a sending device and a receiving device as being “unanswered” based on the values extracted from the SIP message 310 and the rules within the classification rules 330. Here, the classification engine 320 may include logic that can read the rules (in machine-readable format) and interpret the rules by comparing the values to the rules. Furthermore, the classification engine 320 may generate a label 312 that identifies the call outcome and add the label 312 to the SIP messages 310. The labelled SIP messages 310 may be transferred downstream to an analytics system, a storage device, and the like.

FIG. 3B illustrates a view 300B of classification rules that are utilized by the classification engine according to examples and features of the instant solution. Referring to FIG. 3B, shown in the view 300B are a plurality of rules that may be stored in machine-readable format within the classification rules 330 (in a database). The classification engine 320 can use values extracted from SIP messages and apply classification to identify the disposition of a call event based on the rules.

Not all messages are necessary for determining a call disposition. Here, a rule 331 may require the classification engine to identify at least either a 180 RESPONSE to an INVITE or a 200 RESPONSE to an INVITE, before a disposition can be determined. A rule 332 may specify that when a CANCEL message is received, the call outcome is a call that was terminated by the originating party before the terminating party was able to connect the call. A rule 333 may specify that if a RESPONSE message comes through with a failure response code associated, the call outcome was a network failure in initiating the call session.

Other rules may be based on values stored within a header of at least one SIP message. For example, a rule 334 may specify that if a reason field in the header contains the cause code 480, the call was ringing until it went to voicemail. A rule 335 may specify that if the reason field in header contains the cause code of 603, the call was declined by the terminating party. A rule 336 may specify that if the reason field in the header contains the Q.850 code of cause=20, the receiving party had their phone turned off. A rule 337 may specify that if the reason field in the header contains the cause code of 486, the receiving line was busy and the call could not be completed. A rule 338 may specify that if a user agent field in a type of SIP request of 200 RESPONSE to an INVITE request is populated with at least one of a predetermined string value such as “IOS”, “VOLTE”, “MACOS”, “PEERING”, and the like, the call was answered by the receiving device. A rule 339 may specify that if is a history info record field contains a phone number ending in a predetermined number such as 9999, the call was forwarded to a voicemail of the receiving device. A rule 340 may specify that if a 200 RESPONSE to an INVITE request contains a cause code of 302, the call was forwarded to another device.

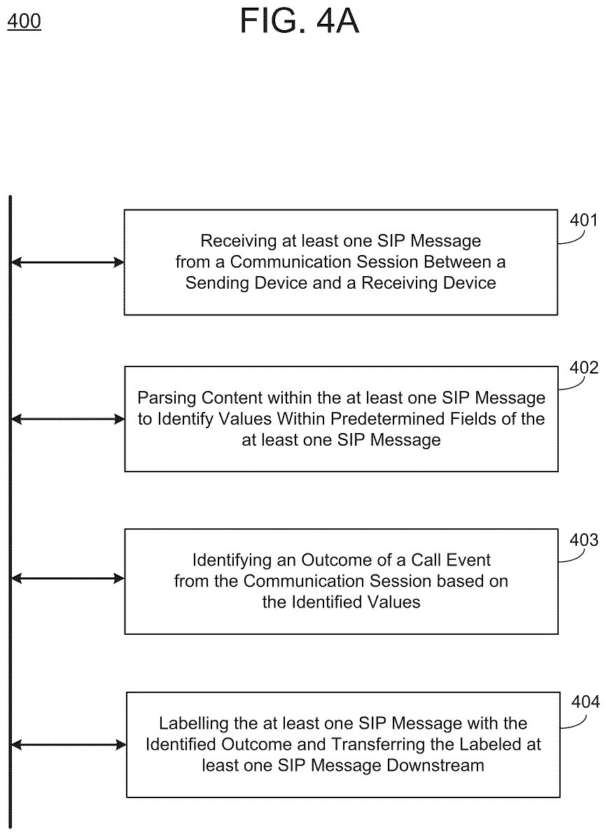

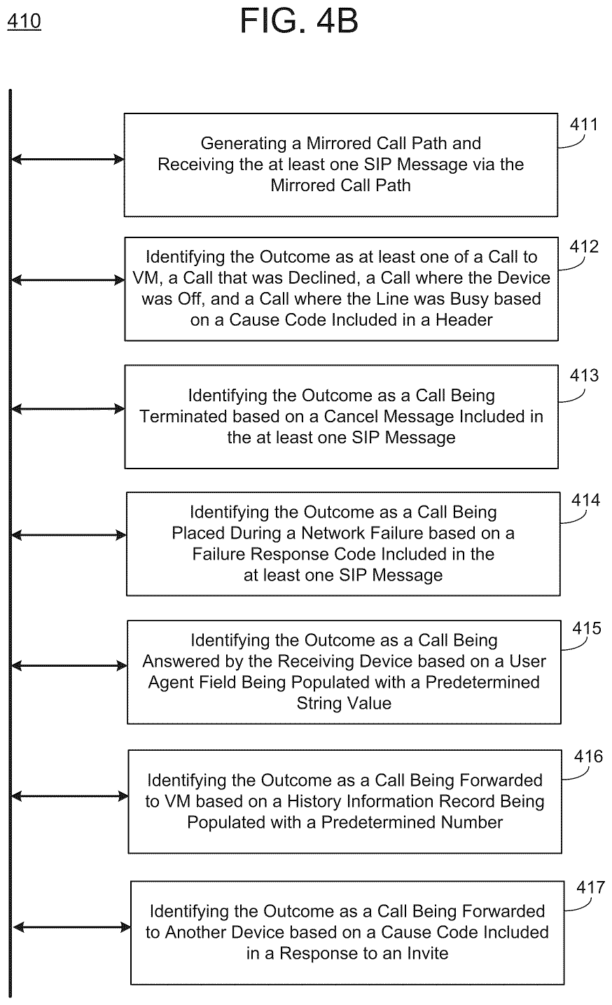

FIG. 4A illustrates a method 400 of determining an outcome of a call according to examples and features of the instant solution. For example, the method 400 may be performed by a host platform such as a cloud platform, a web server, a software application, a combination of systems, and the like. Referring to FIG. 4A, in 401, the method may include receiving at least one session initiation protocol (SIP) message from a communication session between a sending device and a receiving device. In 402, the method may include parsing content within the at least one SIP message to identify values within predetermined fields of the at least one SIP message. In 403, the method may include identifying an outcome of a call event from the communication based on the identified values from the at least one SIP message. In 404, the method may include labelling the at least one SIP message with the identified outcome and transferring the labeled at least one SIP message to a downstream system.

FIG. 4B illustrates an additional method 410 of determining an outcome of a call according to other examples and features of the instant solution. For example, the method 410 may be performed by a host platform such as a cloud platform, a web server, a software application, a combination of systems, and the like. Referring to FIG. 4B, in 411, the method may include generating a mirrored call path from the sending device to the receiving device between the sending device and an apparatus, and receiving the at least one SIP message by the apparatus via the mirrored call path. In 412, the method may include identifying the outcome as at least one of a call that went to voicemail, a call that was declined by the receiving device, a call where the receiving device was off, and a call where the line was busy, based on a cause code included in a header of the at least one SIP message.

In 413, the method may include identifying the outcome as a call being terminated by the sending device based on a cancel message included in the at least one SIP message. In 414, the method may include identifying the outcome as a call placed during a network failure based on a failure response code included in the at least one SIP message. In 415, the method may include identifying the outcome as a call being answered by a human with the receiving device based on a user agent field included in the at least one SIP message being populated with a predetermined string value. In 416, the method may include identifying the outcome as a call being forwarded to a voicemail box based on a history information record included in the at least one SIP message being populated with a predetermined phone number value. In 417, the method may include identifying the outcome as a call being forwarded by the receiving device to another device based on a cause code included in a response to an invite within the at least one SIP message.

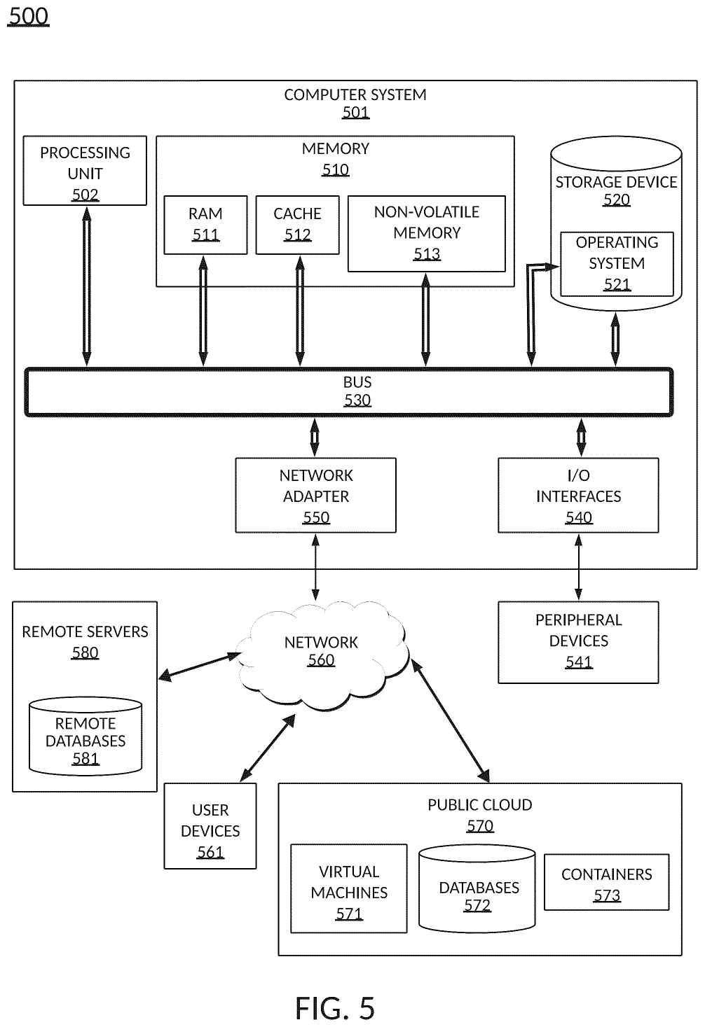

The examples and features of the instant solution may be implemented in one or more of the elements described or depicted herein, including for example, the elements described or depicted in FIG. 5. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 5 illustrates an example computer system architecture, which may represent or be integrated in any of the above-described components, etc.

FIG. 5 illustrates a computing environment according to the instant solution's example features, structures, or characteristics. FIG. 5 is not intended to suggest any limitation as to the scope of use or functionality of features, structures, or characteristics of the instant solution of the application described herein. Regardless, the computing environment 500 can be implemented to perform any of the functionalities described herein. In computing environment 500, there is a computer system 501, operational within numerous other general-purpose or special-purpose computing system environments or configurations.

Computer system 501 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 560 or querying a database. Depending upon the technology, the performance of a computer-implemented method may be distributed among multiple computers and among multiple locations. However, in this presentation of the computing environment 500, a detailed discussion is focused on a single computer, specifically computer system 501, to keep the presentation as simple as possible.

Computer system 501 may be located in a cloud, even though it is not shown in a cloud in FIG. 5. On the other hand, computer system 501 may not be in a cloud except to any extent as may be affirmatively indicated. Computer system 501 may be described in the general context of computer system-executable instructions, such as program modules, executed by a computer system 501. Generally, program modules may include routines, programs, objects, components, logic, data structures, and so on that perform tasks or implement certain abstract data types. As shown in FIG. 5, computer system 501 in computing environment 500 is shown in the form of a general-purpose computing device. The components of computer system 501 may include but are not limited to, at least one processor or processing unit 502, a system memory 510, and a bus 530 that couples various system components, including system memory 510 to processing unit 502.

Processing unit 502 includes at least one computer processor of any type now known or to be developed. The processing unit 502 may contain circuitry distributed over multiple integrated circuit chips. The processing unit 502 may also implement multiple processor threads and multiple processor cores. Cache 512 is a memory that may be in the processor chip package(s) or located “off-chip,” as depicted in FIG. 5. Cache 512 is typically used for data or code accessed by the threads or cores running on the processing unit 502. In some computing environments, processing unit 502 may be designed to work with qubits and perform quantum computing.

Memory 510 is any volatile memory now known or to be developed in the future. Examples include dynamic random-access memory (RAM) 511 or static type RAM 511. Typically, the volatile memory is characterized by random access, but this may not be the characterization unless affirmatively indicated. In computer system 501, memory 510 is in a single package. It is internal to computer system 501, but alternatively or additionally, the volatile memory may be distributed over multiple packages and/or located externally with respect to computer system 501. By way of example, memory 510 can be provided for reading from and writing to a non-removable, non-volatile magnetic media (shown as storage device 520, and typically called a “hard drive”). Memory 510 may include at least one program product having a set (e.g., at least one) of program modules configured to carry out the functions of various features, structures, or characteristics of the instant solution of the application. A typical computer system 501 may include cache 512, a specialized volatile memory generally faster than RAM 511 and generally located closer to the processing unit 502. Cache 512 stores frequently accessed data and instructions accessed by the processing unit 502 to speed up processing time. The computer system 501 may also include non-volatile memory 513 in the form of ROM, PROM, EEPROM, and flash memory. Non-volatile memory 513 often contains programming instructions for starting the computer, including the basic input/output system (BIOS) and information to start the operating system 521.

Computer system 501 may include a removable/non-removable, volatile/non-volatile computer storage device 520. For example, storage device 520 can be a non-removable, non-volatile magnetic media (not shown and typically called a “hard drive”). At least one data interface can connect it to the bus 530. In features, structures, or characteristics of the instant solution where computer system 501 has a large amount of storage (for example, where computer system 501 locally stores and manages a large database), then this storage may be provided by peripheral storage devices 520 designed for storing very large amounts of data, such as a storage area network (SAN) that is shared by multiple, geographically distributed computers.

The operating system 521 is software that manages computer system 501 hardware resources and provides common services for computer programs. Operating system 521 may take several forms, such as various known proprietary operating systems or open-source Portable Operating System Interface type operating systems that employ a kernel.

The bus 530 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 530 is the signal conduction path that allows the various components of computer system 501 to communicate.

Computer system 501 may communicate with at least one peripheral device, 541, via an input/output (I/O) interface, 540. Such devices may include a keyboard, a pointing device, a display, etc.; at least one device that enables a user to interact with computer system 501; and/or any devices (e.g., network card, modem, etc.) that enable computer system 501 to communicate with at least one other computing devices. Such communication can occur via I/O interface 540. As depicted, I/O interface 540 communicates with the other components of computer system 501 via bus 530.

Network adapter 550 enables the computer system 501 to connect and communicate with at least one network 560, such as a local area network (LAN), a wide area network (WAN), and/or a public network (e.g., the Internet). It bridges the computer's internal bus 530 and the external network, exchanging data efficiently and reliably. The network adapter 550 may include hardware, such as modems or Wi-Fi signal transceivers, and software for packetizing and/or de-packetizing data for communication network transmission. Network adapter 550 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 560 is any computer network that can receive and/or transmit data. Network 560 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 560 may be replaced and/or supplemented by LANs designed to communicate data between devices in a local area, such as a Wi-Fi network. The network 560 typically includes computer hardware such as copper transmission cables, optical transmission fibers, wireless transmission, routers, firewalls, switches, gateway computers, edge servers, and network infrastructure known now or to be developed in the future. Computer system 501 connects to network 560 via network adapter 550 and bus 530.

User devices 561 are any computer systems used and controlled by an end user in connection with computer system 501. For example, in a hypothetical case where computer system 501 is designed to provide a recommendation to an end user, this recommendation may typically be communicated from network adapter 550 of computer system 501 through network 560 to a user device 561, allowing user device 561 to display, or otherwise present, the recommendation to an end user. User devices can be a wide array, including personal computers, laptops, tablets, hand-held, mobile phones, etc.

A public cloud 570 is an on-demand availability of computer system resources, including data storage and computing power, without direct active management by the user. Public clouds 570 are often distributed, with data centers in multiple locations for availability and performance. Computing resources on public clouds 570 are shared across multiple tenants through virtual computing environments comprising virtual machines 571, databases 572, containers 573, and other resources. A container 573 is an isolated, lightweight software for running a software application on the host operating system 521. Containers 573 are built on top of the host operating system's kernel and contain software applications and some lightweight operating system APIs and services. In contrast, virtual machine 571 is a software layer with an operating system 521 and kernel. Virtual machines 571 are built on top of a hypervisor emulation layer designed to abstract a host computer's hardware from the operating software environment. Public clouds 570 generally offers databases 572, abstracting high-level database management activities. At least one element described or depicted in FIG. 5 can perform at least one of the actions, functionalities, or features described or depicted herein.

Remote servers 580 are any computers that serve at least some data and/or functionality over a network 560, for example, WAN, a virtual private network (VPN), a private cloud, or via the Internet to computer system 501. These networks 560 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 580 can also host remote databases 581, with the database located on one remote server 580 or distributed across multiple remote servers 580. Remote databases 581 are accessible from database client applications installed locally on the remote server 580, other remote servers 580, user devices 561, or computer system 501 across a network 560. An AI/ML model described or depicted here may reside fully or partially on any of the elements described or depicted in FIG. 5.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

What is claimed is:

1. An apparatus, comprising:
a memory; and
a processor coupled to the memory, the processor configured to:
receive at least one session initiation protocol (SIP) message from a communication session between a sending device and a receiving device,
parse content within the at least one SIP message to identify values within predetermined fields of the at least one SIP message,
identify an outcome of a call event from the communication session based on the identified values from the at least one SIP message, and
label the at least one SIP message with the identified outcome and transfer the labeled at least one SIP message to a downstream system.

2. The apparatus of claim 1, wherein the processor is further configured to generate a mirrored call path from the sending device to the receiving device between the sending device and the apparatus, and receive the at least one SIP message via the mirrored call path.

3. The apparatus of claim 1, wherein the processor is configured to identify the outcome as at least one of a call that went to voicemail, a call that was declined by the receiving device, a call where the receiving device was off, and a call where the line was busy, based on a cause code included in a header of the at least one SIP message.

4. The apparatus of claim 1, wherein the processor is configured to identify the outcome as a call being terminated by the sending device based on a cancel message included in the at least one SIP message.

5. The apparatus of claim 1, wherein the processor is configured to identify the outcome as a call placed during a network failure based on a failure response code included in the at least one SIP message.

6. The apparatus of claim 1, wherein the processor is configured to identify the outcome as a call being answered by the receiving device based on a user agent field included in the at least one SIP message being populated with a predetermined string value.

7. The apparatus of claim 1, wherein the processor is configured to identify the outcome as a call being forwarded to a voicemail box based on a history information record included in the at least one SIP message being populated with a predetermined phone number value.

8. The apparatus of claim 1, wherein the processor is configured to identify the outcome as a call being forwarded by the receiving device to another device based on a cause code included in a response to an invite within the at least one SIP message.

9. A method comprising:
receiving at least one session initiation protocol (SIP) message from a communication session between a sending device and a receiving device;
parsing content within the at least one SIP message to identify values within predetermined fields of the at least one SIP message;
identifying an outcome of a call event from the communication session based on the identified values from the at least one SIP message; and
labelling the at least one SIP message with the identified outcome and transferring the labeled at least one SIP message to a downstream system.

10. The method of claim 9, wherein the method further comprises generating a mirrored call path from the sending device to the receiving device between the sending device and an apparatus, and receiving the at least one SIP message by the apparatus via the mirrored call path.

11. The method of claim 9, wherein the identifying comprises identifying the outcome as at least one of a call that went to voicemail, a call that was declined by the receiving device, a call where the receiving device was off, and a call where the line was busy, based on a cause code included in a header of the at least one SIP message.

12. The method of claim 9, wherein the identifying comprises identifying the outcome as a call being terminated by the sending device based on a cancel message included in the at least one SIP message.

13. The method of claim 9, wherein the identifying comprises identifying the outcome as a call placed during a network failure based on a failure response code included in the at least one SIP message.

14. The method of claim 9, wherein the identifying comprises identifying the outcome as a call being answered by the receiving device based on a user agent field included in the at least one SIP message being populated with a predetermined string value.

15. The method of claim 9, wherein the identifying comprises identifying the outcome as a call being forwarded to a voicemail box based on a history information record included in the at least one SIP message being populated with a predetermined phone number value.

16. The method of claim 9, wherein the identifying comprises identifying the outcome as a call being forwarded by the receiving device to another device based on a cause code included in a response to an invite within the at least one SIP message.

17. A computer-readable hardware storage medium comprising instructions which when executed by a processor cause the processor to perform:
receiving at least one session initiation protocol (SIP) message from a communication session between a sending device and a receiving device;
parsing content within the at least one SIP message to identify values within predetermined fields of the at least one SIP message;
identifying an outcome of a call event from the communication session based on the identified values from the at least one SIP message; and
labelling the at least one SIP message with the identified outcome and transferring the labeled at least one SIP message to a downstream system.

18. The computer-readable hardware storage medium of claim 17, wherein the processor is further configured to perform generating a mirrored call path from the sending device to the receiving device between the sending device and an apparatus, and receiving the at least one SIP message by the apparatus via the mirrored call path.

19. The computer-readable hardware storage medium of claim 17, wherein the identifying comprises identifying the outcome as at least one of a call that went to voicemail, a call that was declined by the receiving device, a call where the receiving device was off, and a call where the line was busy, based on a cause code included in a header of the at least one SIP message.

20. The computer-readable hardware storage medium of claim 17, wherein the identifying comprises identifying the outcome as a call being terminated by the sending device based on a cancel message included in the at least one SIP message.
